(19) United States
(12) Patent Application Publication
(10) Pub. No.: US 2025/0105628 A1
(43) Pub. Date: Mar. 27, 2025

(54) METHOD - INCLUDING ENERGY STORAGE METHOD - FOR SUPPLYING ENERGY IN THE VICINITY OF THE POINT OF CONSUMPTION USING REGENERATIVE ENERGY SOURCES, AND USE THEREOF

(71) Applicants: Wolfgang HARAZIM, Zwickau (DE); EXCELLENCE - GESELLSCHAFT ZUR OBHUTSVERWALTUNG ERLESENER LIEGENSCHAFTEN UND VERMÖGENSANLAGEN MBH, Frankfurt/ Main (DE)

(72) Inventor: Wolfgang HARAZIM, Zwickau (DE)

(73) Assignees: Wolfgang HARAZIM, Zwickau (DE); EXCELLENCE - GESELLSCHAFT ZUR OBHUTSVERWALTUNG ERLESENER LIEGENSCHAFTEN UND VERMÖGENSANLAGEN MBH, Frankfurt/ Main (DE)

(21) Appl. No.: 18/709,434

(22) PCT Filed: Jun. 9, 2023
(86) PCT No.: PCT/EP2023/000034

§ 371 Date: May 10, 2024

(30) Foreign Application Priority Data
Jun. 13, 2022 (DE) 10 2022 002 127.7

(51) Int. Cl. H02J 3/38

(52) U.S. Cl. CPC H02J 3/381; H02J 2300/24; H02J 2300/28

(57) ABSTRACT

A universal application method including an energy storage process for supplying energy in the vicinity of the point of consumption using regenerative energy sources and to the use thereof. The application quality consists in the reliable supply of current in an autonomous as well as network-integrated manner in the vicinity of the point of consumption without specific location requirements and with an automatic and reliable operation which can be remote-controlled, high storage and distribution cycles with short reaction times and without self-discharges or degeneration, a low auxiliary energy consumption, low operating costs, a high degree of environmental compatibility with a high degree of efficiency, and a long calendar service life which is conterminous with the building.

### TECHNICAL FIELD

The present application relates to a “universal usage method including electricity storage for near-consumption power supply with renewable energy sources and its application”, which can be used primarily in the energy industry.

### BACKGROUND

The change from the use of fossil energy to renewable energy sources requires a new energy supply infrastructure. Base, medium and peak load power plants have so far carried out the network load adjustment in a planned manner, which was used specifically through appropriate stockpiling depending on the electricity requirement. The availability of wind and solar energy as the main energy sources temporarily does not match the demand for electricity, so that storage is becoming increasingly important for functional reasons, on the one hand to ensure frequency stability and on the other hand to provide the required amounts of electricity throughout the day and night.

The requirements for the usable storage technologies are high. In addition to economic efficiency, safety, environmental compatibility and longevity, technical requirements for the energy efficiency of storage systems dominate. This includes storage capacity, energy density, storage duration, response time, cycle stability and efficiency, because the proceeds from the ratio of effort to benefit (electricity price input to electricity price output) offset the costs of structure and operating the storage.

Except in superconducting coils or capacitors in special applications, electrical energy cannot be stored directly, which requires additional lossy conversions into forms of energy that can be stored. According to the prior art, potential, electrochemical, kinetic, chemical and thermal energy have become established as intermediate storage with the respective special conversion processes. This results in differences in terms of possible capacity and storage duration, whether these can be used as reserve, short-term or long-term storage and how quickly can one react to load changes with high cycle stability. As with pumped or compressed air storage plants, are there special location requirements or can the storage be set up near important network nodes.

Driven also by e-mobility, electrochemical energy storage in batteries or accumulators is at a high level of development. The advantages of short response times with automatic, efficient operation at a comparatively high energy density are clouded by self-discharge, limited charging cycles and expensive raw materials, which calls into question the economic viability on an industrial scale. The disposal of used battery cells or, better yet, the ability to recycle them is still unsolved on a large scale.

In “Power to Gas” processes, energy is stored chemically in the calorific value of hydrogen, which is created during electrolysis by adding water and electricity in addition to oxygen. Whether this is further converted into synthetic methane in a hydrogenation process or directly in a fuel cell or in a power process as needed depends on the planned use. However, at least 50% of the electricity input can no longer be converted back, which calls this technology into question as a pure electricity storage without heat and power coupling.

The focus of the research is on the so-called “Carnot batteries” (Physic Journal 14 (2015) No. 2), which are predicted to use thermal energy highly efficiently for intermediate storage. When there is an oversupply of electricity, a heat pump process is supposed to load a special high-temperature heat storage device by absorbing work and heat at a low temperature level, which then supplies heat of evaporation to a power process when electricity is needed to adapt the load (Patent EP 1987299 B1 2007). In addition to the unavoidable temperature gradient when loading and unloading the high-temperature heat storage and the effort required to provide the low-temperature heat source, high stand-by losses arise in the steam power process in order to keep it operational. As the storage time increases, the response time decreases due to long start-ups and the efficiency decreases due to self-discharge, which limits the usability.

Compressed air storage power plants use excess electricity to compress air and store it underground in caverns. The sliding pressure gradient generated by the compressor increases the potential energy, which drives a turbine for reconversion of electricity when the pressure expands. The principle is simple and the efficiency increases with stored compression heat if it preheats the air before expansion. Can be used on an industrial scale with good efficiency if the local geology allows it, e.g. leachable salt domes (cavemen), as very large, pressure-resistant storage volumes are required.

The dominant storage technology on a large scale is pumped storage plants, which use the positional energy changes of water between the upper and lower basins. With very good efficiency with fast availability and short switch-on and switch-over times, there are hardly any storage losses, apart from system friction, water losses through evaporation or seepage and waste heat from electricity conversion. The use requires significant landscape intervention in special terrain topography, which is why this type of electricity storage remains limited.

Energy storage based on positional energy by hydraulically lifting a rock mass as described in DE 10 2010 034 757 B4 increases the lifting weight, but requires a secure and difficult-to-implement seal between the lifting cylinder and the ground. In the event of failure, the rock mass sinks to the ground and the displaced water floods the surrounding area.

Hub storage systems, as proposed in DE 10 2007 057 323 A1, also use positional energy to temporarily store electricity by mechanically raising (loading) or lowering (unloading) a weight using a hoist, a principle that clock makers have been using for a long time to operate tower clocks. The idea of sinking a large mass deep into the earth to utilize existing disused shafts makes sense, but limits application to former mining areas. As long as the dewatering costs over the service life of the storage facility do not reduce its revenue too much, the combination of lifting gear in a shaft meets most of the storage technology requirements, with the exception of the location requirements.

Although electricity storage is becoming more and more important functionally because large turbines that were able to smooth out frequency fluctuations with their rotor masses are gradually being taken off the network, the market and earnings conditions for storage operators are also difficult due to network fees, levies, taxes, own consumption and levies. The legal framework is constantly changing, which makes long-term monetary planning difficult and requires a high level of flexibility.

The fictitious energy technology expert knows the storage technologies with all their advantages and disadvantages, improves efficiency, knows the economic constraints and the location requirements of the individual variants. However, solutions to the underlying requirements for the tasks of the invention according to the prior art are missing. These consist of:
flexible choice of location, taking into account urban development guidelines for a consumption-oriented, frequency-stable power supply with renewable energy sources that can be operated independently and/or in a network connection,
flexible adaptation to changing market and earnings conditions through possible changes in operating mode,
a long calendar lifespan with a consistently high level of system utilization,
high operational reliability with low potential for damage,
very short response times with a small-scale, modulable power supply to adapt to the network load,
a high number of input and output storage cycles without self-discharge with automatic, remote-controllable operation,
high environmental compatibility during production, use and dismantling (complete recyclability),
low operating costs with low auxiliary energy consumption.

### SUMMARY

According to the present application, the object is essentially solved by the features characterizing claims 1 to 7. The universal usage method including electricity storage for near-consumption power supply with renewable energy sources and its application achieved through the procedural measures, storage of fluctuating electricity supplies with short reaction times for network load adjustment, based on many separately controllable lifting modules, using positional energy in a protected structure, with simultaneous double use of the base area through photovoltaics and/or wind turbines, a new application quality. It consists of a secure, self-sufficient and network-integrated power supply close to the consumer using renewable energy sources without any specific location requirements.

As is well known, mechanical hub storage uses the positional energy to temporarily store electricity in a highly efficient and self-discharge-free manner. The losses per cycle are less than 10% for power conversion and friction. Instead of moving a heavy lifting storage facility into deep, limited old shafts, it becomes location independent if the lifting height is reduced to a structure format. With the same capacity, the number of lifting modules and the associated space requirement increase significantly. Photovoltaic systems also require large installation areas, which do not allow for dual use except on roofs. In an appropriately designed tall structure, electricity storage and generation can be accommodated in a space-saving and efficient manner, creating a load-dependent power supply for fluctuating energy sources.

A lifting module 4 consists of a winch, at the end of rope or chain hangs a weight which is raised or lowered depending on the motor/generator operation. Each module interacts with the network as a separately controllable individual cell, has its own power conversion with a data bus connection and feeds in or withdraws power in a matter of seconds, depending on the requirements. Rope and chain winches are at a high technical level due to elevator and crane construction. Modern control and regulation technology combined with tried-and-tested mechanics result in a flexible storage technology that will still exist in 100 years in terms of efficiency and handling.

From an economic point of view, there are various options for the load-bearing power supply with fluctuating energy sources, including storage, which influence the production costs. With the same storage capacity, both the lifting height and the lifting weight of the individual modules determine the required floor space. The choice of material determines the number of lifting modules and thus the price, whether the weight consists of iron with 7.8 t/m³, concrete with 2.4 t/m³ or a vessel filled with water with 1 t/m³. Is a clad steel structure sufficient as a structure or does it have to be a solid concrete structure that has to fit into the urban planning context in terms of height and design. In addition to the price advantage due to large quantities of the same lifting modules at the respective location, these factors enable a high degree of monetary variability. The dual use of the floor space through storage and photovoltaics on the roof with the additional south wall option improves the earnings situation through mixed calculations, and supplies its own electricity, which can be increased by wind turbines on the corners of the structure. If there is also a biomass power plant in the nearby area on standby as a reserve for lulls, it can be activated depending on the storage charge level and the weather. The many individually controllable lifting modules ensure frequency stability depending on the load, meaning that the power network remains functionally reliable even with fluctuating renewable energy sources, whether operated independently or in a network. An important prerequisite for the flexible power supply of the future in order to be able to do without fossil or nuclear energy sources.

The universal usage method including electricity storage for near-consumption power supply with renewable energy sources and its application also meets the other requirements. It does not require a terrain-specific topology and can be flexibly adapted to changing market and yield conditions, as storage, photovoltaics and wind power can be operated dependently or independently of one another depending on the market situation. It enables automatic, safe, remote-controllable operation, high storage and withdrawal cycles with very short reaction times and all of this without self-discharge, degeneration, low auxiliary energy consumption, low operating costs, high efficiency, high environmental compatibility and a long service life adjacent to the structure with complete recyclability afterwards.

### BRIEF DESCRIPTION OF THE DRAWINGS

FIG. 1 shows the principle universal usage method including electricity storage for near-consumption power supply with renewable energy sources and its application.

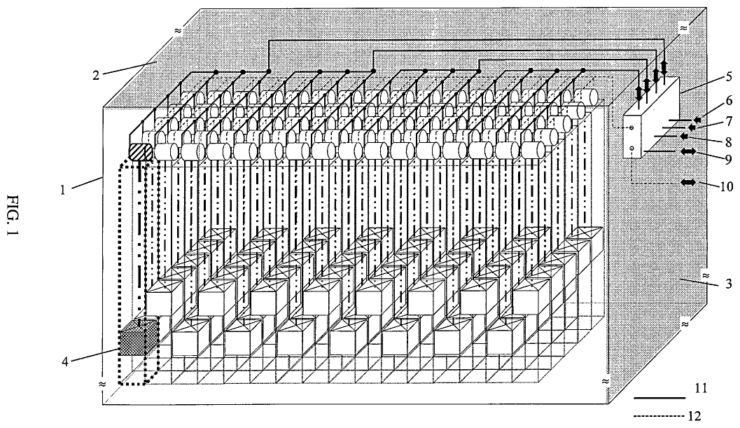

In the drawings:
1 structure
2 roof
3 south side
4 lifting module
5 central computer-aided control unit
6 photovoltaics
7 wind turbines
8 biomass power plant
9 network
10 remote control
11 power line
12 data bus line

### DETAILED DESCRIPTION

Depending on the planned storage capacity in accordance with monetary considerations, many individually controllable lifting modules 4 are installed in the structure 1, which are connected to the central computer-aided control unit 5 by means of power lines 11 and data bus line 12. The input current reaches the central computer-aided control unit 5 via power lines 11 and comes from the photovoltaics 6 on the roof 2 or south side 3, from wind turbines 7, from the biomass power plant 8 or from surplus electricity from the network 9. Depending on the operating mode, whether self-sufficient as an island network or in a network, remote control 10 from the network operator is possible. The central computer-aided control unit 5 can be flexibly programmed depending on the market and yield conditions as to whether the input stream from 6, 7 and or 8 is forwarded and billed as output via the network 9, or whether a part is temporarily stored via the lifting modules 4 to be able to feed it in more profitably later when the load is reduced. The same also applies to cheap surplus electricity from the network. A skill that is particularly important for operators during the transition period on the way to renewable energy supply. This means that each network can automatically operate at a stable frequency with a long service life and consistently high efficiency, even if the large rotor masses of the turbines are missing. The tasks are now completely solved. The universal usage method is particularly suitable for the strongly fluctuating load changes in railway operations when e-locks start up or feed in electricity when braking. The location near the railway network does not require any other requirements other than the required floor space.

With the combination of storage, control and self-generated electricity using renewable energy sources in one place in a structure, which neither require topological conditions like pumped storage plants, nor geological ones like compressed air power plants, which rely on leachable salt domes for the pressure storage, a functionally reliable, highly flexible, long-lasting, highly efficient power supply is available for photovoltaics without requiring additional space if the dimensions are appropriate. With a steel framework construction, the material value also increases after a possible 100 years of use. Another option is for former open brown coal opencast mine extinguishers, which, instead of being flooded with water, use the cavity up to the earth's surface through appropriate large-scale lifting structures for storage and photovoltaics.

1. A Universal usage method including electricity storage for near-consumer power supply with renewable energy sources and its application, consisting of known technological methods for the use of positional energy by means of a hub storage plant, the use of solar energy by means of photovoltaics, the use of wind energy by means of a wind turbine and the use of biomass by means of thermal power plants, which interact with a power network and/or a self-sufficient power network,
characterized in that:
a) the lifting height of a lifting storage facility is determined by locally permissible structure formats,
b) the total lifting load resulting from the planned storage capacity and the lifting height is divided among individual lifting modules (4),
c) a lifting module (4) consists of a winch with motor/generator operation and a vertically guided lifting weight, which is connected to the winch by a rope or chain,
d) each lifting module (4) is equipped with its own power conversion and is controlled separately via a data bus connection,
e) the individual size of a lifting module (4) is determined in a cost-optimized manner by weighing up the choice of material for the lifting weight and the standardizable series production of the winches in large quantities,
f) the cost-relevant enclosed space of the lifting power plant is determined with the selectable area-height ratio of the lifting module weights,
g) the number of lifting modules (4) determines the floor space requirement for the structure (1) of the lifting storage plant,
h) the base area of the structure (1) is doubled by the sunny areas on the roof (2) and the south side (3) is also used by photovoltaics,
i) it can be used universally in consumer areas without geological, specific or topological location requirements,
j) the modular structure achieves universal scaling of the storage capacity while maintaining the same efficiency,
k) the separate power conversion with data bus control of the respective lifting modules (4) is connected directly to the network (9) to be regulated by a central computer-aided control unit (5),
l) from a central computer-aided control unit (5) via the data bus with the individual control of the lifting modules (4), the network load is regulated in a matter of seconds, flexibly, precisely, remotely controllable and automatically in the range of 0-100% of the storage capacity through modulable feed-in current quantities,
m) electricity, whether from photovoltaics (6), from wind turbines (7), from the biomass power plant (8) from self-generation or surplus electricity from the network (9), is stored in the lifting modules (4) according to type and fed back flexibly depending on market and yield conditions with regard to network fees, levies, taxes, own consumption or levies,
n) the high number of lifting modules (4) ensures a high level of operational reliability, even if individual ones fail.

2. The method according to claim 1, characterized in that: wind energy is used by wind turbines on the roof or around the structure (1) at suitable locations to increase local electricity generation.

3. The method according to claim 1, characterized in that: in order to bridge a longer lull in energy sources, the electricity bottleneck is compensated for stabilization by weather-controlled, switchable thermal biomass power plants.

4. The method according to claim 1, characterized in that: due to the high efficiency until the end of the useful life and because of the recyclable construction and materials, the environment is minimally polluted.

5. The method according to claim 1, characterized in that: with the choice of the lifting height, the qualitative demands on the respective structure (1) and the dimensioning of the individual module, a high case-related monetary variability in terms of dimensions and material is achieved.

6. The method according to claim 1, characterized in that: it can be started without additional auxiliary energy and the state of charge is maintained without loss when not in use.

7. The method according to claim 1, characterized in that: a part of the hub storage regulates the network load adjustment, while at the same time excess electricity is stored in the other part.
